(19) United States
(12) Patent Application Publication
(10) Pub. No.: US 2009/0165942 A1
(43) Pub. Date: Jul. 2, 2009

(54) Insulation and Method of Installing

(75) Inventors: James W. Nowicki, Hopewell, NJ (US); Salvador Alvarado-Trevino, Belle Mead, NJ (US); Shirish Sawale, Bridgewater, NJ (US)

Correspondence Address: NATIONAL STARCH AND CHEMICAL COMPANY, P.O. BOX 6500, BRIDGEWATER, NJ, 08807-3300, US

(73) Assignee: National Starch and Chemical Investment Holding Corporation, New Castle, DE (US)

(21) Appl. No.: 11/964,268

(22) Filed: Dec. 26, 2007

(51) Int. Cl. B29C 65/00; B32B 13/00

(52) U.S. Cl. 156/273.7; 428/346

(57) ABSTRACT

Insulation blankets having preapplied thereon a reactivatable hot melt adhesive.

### FIELD OF THE INVENTION

The invention relates to insulation blankets used in products, typically the interior of products, for thermal and/or acoustical purposes. The insulation comprises a reactivatable hot melt adhesive pre-applied to at least a portion thereof.

### BACKGROUND OF THE INVENTION

Sheets and rolls of insulation are often bonded to the inside of home and industrial equipment and appliances (products) for the purpose of sound deadening and/or as a thermal barrier. Typically the insulation is attached with an adhesive at the product assembly plant by applying the adhesive to the insulation itself, or by applying the adhesive to the wall or specific area of the product to be insulated. The insulation is then pressed onto the product to form the bond. Application of the adhesive in the product assembly plant causes problems because the adhesive can contaminate surfaces of the product where it does not belong. The manufacturing company is also required to devote a tremendous amount of time and attention to adhesive-related issues, including adhesive selection, processing, trouble-shooting, inventory, and maintenance of adhesive application equipment. In addition, most assembly line workers do not have sufficient skill or knowledge to use, clean, maintain, or repair the adhesive pumping and delivery systems and, therefore, technicians skilled in the adhesive arts are essential members of the work force.

A need exists in the art for novel types of insulation and methods of installing insulation in products requiring the use thereof that is simple and economical to use. The current invention addresses this need.

### SUMMARY OF THE INVENTION

One embodiment of the invention is directed to insulation blankets and the like comprising a reactivatable hot melt adhesive, and to methods of preparing insulation blankets. The insulation is provided to the manufacturer with adhesive already applied to the insulation and later during the product assembly process, re-activated in order to secure the insulation to the product. The insulation blankets of the invention are prepared by applying a molten hot melt adhesive to a surface of the insulation and allowing the adhesive to cool/solidify thereon.

Another embodiment of the invention is directed to products of manufacture, such as but not limited to residential and commercial equipment and appliances, which products comprise insulation that was installed, or otherwise secured in place, by the reactivation of a hot melt adhesive present on a surface of the insulation. Products include but are not limited to cooking ovens, HVAC (heat ventilation and air conditioning) units, automobile hoods, entry and passage doors, mobile home components, recreation vehicle (RV) panels, rail car panels, and the like.

Still another embodiment of the invention is directed to a method of installing insulation and manufacturing products, such as but not limited to residential and commercial equipment and appliances. The method comprises reactivating a hot melt adhesive preapplied to a substrate surface of the insulation, contacting the reactivated adhesive to a substrate surface of a product to be insulated, typically at a predetermined location of said product, and allowing the reactivated adhesive to cool and solidify, whereby the insulation is bonded to said product. The invention eliminates problems associated with using adhesives in a product appliance assembly plants and increases productivity.

The invention also may advantageously be used in insulation laminating processes.

The hot melt adhesive composition used in the practice of the invention comprises an effective amount of an energy-absorbing ingredient such that upon exposure of the adhesive to radiant energy, the adhesive is activated. The energy-absorbing ingredient selected for use may be dissolved and/or dispersed within the adhesive composition. Organic dyes and pigments are particularly useful energy-absorbing ingredients for use in the practice of the invention. Upon exposure to radiant energy, the adhesive melts to the extent that it is capable of bonding one substrate surface (i.e., the substrate to which the adhesive was preapplied) to a second substrate surface. A particular preferred embodiment of the invention comprises an insulation blanket comprising reactivatable hot melt adhesive containing a near infrared energy absorbing ingredient.

### DETAILED DESCRIPTION OF THE INVENTION

The invention is directed to insulation batting, also referred to herein as insulation blankets or insulation panels, having adhesive already applied to and comprising a part of the fabricated insulation.

The adhesive layer that is coated onto the insulation is easily activated with a near infra-red energy source. The activated adhesive layer is then pressed onto a surface area of a product to be insulated and allowed to solidify, thereby bonding the insulation the product. This eliminates the possibility of contaminating surfaces where the adhesive does not belong. Since the adhesive is already a part of the insulation components, there is no equipment or worker skill required to apply the adhesive in the appliance assembly plant. Use of the near infra-red energy source is as simple as passing the parts underneath a near IR light source.

The insulation is used in the manufacture of products requiring protection from sources of heat, cold and/or sound. Typically insulation of the invention will be applied to the inside of home and industrial equipment and appliances such as but not limited to HVAC (heat ventilation and air conditioning) units, water heaters, ovens, etc. Further examples include pipes (e.g., gas, water), under automobile hoods for use as a sound barrier, use in the manufacture of entry or passage doors, mobile home components, RV panels and rail car panels. While such end use articles are generically referred to herein and in the claims as articles or products, alternative terms such as appliances or equipment, except as used in the claims, is not to be used to limit the products described herein.

While the process of bonding insulation to a product will typically be conducted in an assembly line operation, it will be appreciated that the insulation can also be used in the field, using a portable NIR source of energy. As such, the insulation of the invention may also be advantageous used in commercial and residential housing construction and the like, such as for insertion and retention in wall, floor, ceiling and roof pockets and cavities.

The invention also provides the art with a method of easily removing insulation or a section thereof, for purpose of repairing the appliance or other insulated article. The insulation may be removed by reactivating the adhesive. Following repair, the adhesive can again be reactivated and replaced. Alternatively, an insulation replacement patch comprising a preapplied reactivatable hot melt adhesive may be used. Replacement patches may also be used to replace damaged insulation.

In a separate application, also encompassed by the invention, the adhesive can be preapplied to insulating components and used and activated for laminating of insulating components. Insulation can be coated with the adhesive. At any later time (minutes, days, weeks, or years) the adhesive coated insulation can be activated with near infra-red energy and bonded to films, papers, or other roll stocks to form a lamination. Any number or combination of laminations is possible.

The invention eliminates problems associated with using adhesives in assembly plants, and increases productivity in the assembly plant or the insulation laminating process.

The insulation used in the practice of the invention is typically an elongated insulation blanket made of a fibrous material, a foam, an aerogel, or composites thereof. The insulation may desirable be delivered to the installer/manufacturer in the form of pre-cut batts, and may even be precut for custom fitting of the insulation blanket so that it can be handled as a unit. It is to be understood that the term “blanket” is used broadly herein and that manufacture of insulation blankets can be made in any desired shape for a particular end use application. Insulation blankets or tubes made in shapes particularly useful for insulating pipes, e.g., steam pipes, hot water pipes, etc., are encompassed by the invention. It will also be understood that insulation blankets may be manufactured that have a three dimensional form and/or that have some resilience, rigidity, or flexibility that will facilitate its installation to a specifically configured product.

The insulation blankets of the invention may be faced or unfaced.

Non-limiting examples of fibrous materials that can be used in the practice of the invention include glass fibers, mineral fibers such as rock wool fibers, slag fibers and basalt fibers and inorganic fibers such as polypropylene, polyester and other polymeric fibers. Examples of organic polymer based cellular insulation include HDPE/LLDPE, PP and such polymers. Use of aerogel and aerogel composites are encompassed. It is to be understood that this list is not exhaustive and the invention can be used with any insulation material—fibrous, foam or otherwise—used in the insulation arts.

Useful facings or facing sheets for the insulation blankets of the invention may be made of kraft paper, a foil-scrim-kraft paper laminate, or a polymeric film, such as but not limited to polyethylene, and are bonded to a major surface of the fibrous insulation blanket. Again, this list is this list is not exhaustive and the invention can be used with any facing material used in the insulation arts.

For ease of description only, it will be recognized that the insulation blanket will have a front and back major surface, and first and second side surfaces. In one embodiment, one major surface will have a facing sheet adhered thereto and the other major surface will have the reactivatable hot melt adhesive preapplied thereto. It is to be understood that the adhesive can be applied to either or both major surfaces.

The adhesive formulations of the invention may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary. The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer), electrostatic, vapor deposition, fiberization and/or screen printing. While the method of pre-application to the insulative substrate is not critical to the practice of the invention, swirl spraying has been found to be particularly advantageous.

Reactivation, as this term is used herein, refers to an adhesive that resides on at least a portion of at least one substrate to be bonded. In the context of a hot melt adhesive, the adhesive has been applied to a substrate in the molten state and allowed to cool, i.e., solidify, thereon. The adhesive present on the substrate is thereafter reactivated or heated to a molten state, brought in contact with a second substrate and allowed to cool or solidify, thereby bonding the two substrates together. The application of the adhesive onto a substrate for later activation or “reactivation” is referred to herein, and in the art as a “pre-applied” adhesive.

The reactivation efficiency of an adhesive refers to the ability of the adhesive to reactive, e.g., become molten in a short period of time. Reactivation efficiency will depend on the power of the energy source and the distance of the energy source from the adhesive. Reactivation time depends on receptivity of the adhesive, which depends on the energy absorbing ingredient, the coating weight or thickness of the adhesive and the energy flux density that the radiant source can supply to the adhesive (e.g., intensity per unit area). Energy flux density refers to the distance, focal point, power and intensity of the lamp or power source.

Preferably, the reactivatable adhesives are formulated to reactivate to a temperature of at least about 200° F., more preferably to a temperature of at least about 250° F. upon exposure of less than about 1200 watts/sq inch of near infrared energy for a period of less that about 10 seconds, more preferably less than about 5 seconds, even more preferably less than about 2 seconds.

It will be appreciated that the pre-applied adhesive insulation piece can be activated multiple times. The adhesive that is preapplied to and forms a part of the insulation blanket of the invention provides the art with a product that can be re-activated multiple times and still be used. The invention this provides a significant advantage compared to existing adhesive technologies currently used in appliance plants. Currently, adhesive is sprayed onto the substrate surface and then must used immediately or at least within the specified open time of the adhesive. By using the pre-applied treated insulation of the invention, activation can take place and then, if an unrelated process interruption or other delay occurs which goes beyond the open time of the reactivated adhesive, the insulative product can be activated yet again and used for bonding the insulation to the e.g., appliance or other article.

It will also be appreciated that the insulation of the invention can be used to repair or replace insulation that as been damaged or purposely removed. Insulation may, for example, be applied in the plant during manufacture of the insulated article, and then at a later time the adhesive can be activated in the field, removed, repair work performed (e.g., on the appliance, pipe, or the like), and then the adhesive can yet again be activated and the insulation reattached to the repaired appliance. Alternatively, insulation that has been damaged or deliberately removed for e.g., purpose of repair, can be replaced with pieces of insulation manufactured specifically for repair purposes. It is understood that prior art preexisting insulation can be fixed or repaired on site using the insulation of the invention.

The adhesive composition applied to the insulating substrate contains an energy absorbing ingredient that increases the absorption and reduces the transmission of radiant energy that creates a temperature distribution within the adhesive that optimizes performance. The adhesives have improved re-activation and performance properties after irradiation. The adhesives of the invention reactivate on exposure to short durations of radiant energy and provide superior on-line performance and set speed that allows for quicker production speeds.

The improved re-activation and performance is achieved by incorporating into a hot melt adhesive an energy-absorbing ingredient. Energy-absorbing ingredients include those dyes, pigments, fillers, polymers, resins, and/or other ingredients that are capable of absorbing energy and provide an optimal balance of absorption, reflection, transmission and conduction.

It has been discovered that when a suitable energy-absorbing ingredient is added to a hot melt adhesive, reactivation upon short duration of radiant energy can be achieved. Energy-absorbing ingredients contemplated for use in the practice of the invention are commercially available and include, but are not limited to dyes, pigments and fillers. Examples include carbon black, graphite, Solvent Red (2′,3-dimethyl-4-(2-hydroxy-naphthylazo)azo-benzene), Solvent Green, dyes such as Forest Green and Royal Blue masterbatch dye available from Clariant, cyanine-based dyes, oxides such as such as titanium dioxide, and metals such as antimony, tetrakis)dialkylaminophenyl)aminium dyes, cyanine dyes, squarylium dyes and the like.

Pigments, such as carbon black and graphite, are particulate in nature and will usually have somewhat of a spherical shape with average particle sizes in the range of about 0.01 to about 7 microns. Pigment particles aggregate, so aggregate size will be larger. The pigment aggregate size in hot melt adhesives will preferably be smaller than about 500 microns. Aggregate sizes of less than about 100 microns are preferred, more preferably smaller than about 50 microns.

A wide variety of organic NIR triggers are described in the literature and are available for use in the practice of the invention. Such compounds include cyanine, metal complexes, quinone, azo, radical multiphenylmethane, perylene, aromatic annulenes, and fluorenylium. Such triggers possess various absorption characteristics. For example, halogen substituted 1,4,5,8-tetraanilioanthraquinones have excellent transmittance in the vicinity of 860 nm and can absorb NIR in other ranges. Another example is squaraine, which is characterized by intense narrow absorption bands at relatively long wavelength. Also specifically designed phthalocyanine compounds have been demonstrated exhibiting high transmittance to visible light and offering high efficient cut of near infrared.

Preferred energy-absorbing ingredients for use in the practice of the invention are broad band near IR absorbers such as Epolight 1125 (Epolene, Inc), SDA6248 (H.W. Sands Corp.), SDA2072 (H.W. Sands Corp.) and carbon black. Carbon black can be purchased from Cabot under trade name of Monarch, Regal, Black Pearl, and Elftex, or Degussa (FW series), or from Columbian Chemical Company (Raven Series). Carbon black can be manufactured by different methods such as the furnace black method, the gas (channel) black method, and the lamp black method. The key parameters affecting the radian energy absorption of carbon black prepared by these various methods are average primary particle size, surface chemistry and aggregate structure.

Energy absorbing ingredients for use in the practice of the invention will typically have an absorption in the range of from about 400 nm to about 100,000 nM, more preferably from about 700 nm to about 10,000 nm, even more preferably from about 750 nm to about 5000 nm.

Suitable energy-absorbing ingredients for use in the reactivatable adhesives used in the practice of the invention may be identified by blending a desired adhesive with a chosen additive of various particle size and various amounts. Any conventional method of blending the energy-absorbing ingredient with the adhesive such as through use of a paddle mixer or high shear mixer such as Ross ME-100LC extruder, as would be apparent to the skilled practitioner, may be used to prepare the adhesive compositions of the invention. The starting adhesive and the adhesive containing the energy-absorbing ingredient then are compared by heating samples of each with a light from a radiant heat source. The samples are tested for reactivation efficiency and bonding performance, as described in detailed in the Examples. Reactivation efficiency is the ability the adhesive to become molten in a short period of time. Suitable additives are those that reactivate quickly and exhibit acceptable bond strength. Preferred are thermoplastic adhesives which, when pre-applied to a substrate, re-activates with a short duration of exposure to radiant energy, preferably less that about 10 seconds, more preferably less than about 5 seconds, and provides acceptable bond force after a short period of compression or cooling, preferably a period of less that about 30 seconds, more preferably less than about 15 seconds.

Included in the practice of the invention are adhesives comprising absorber coated fillers and encapsulated absorbers. For example, the adhesive may comprise a cureative encapsulated within a shell comprising a NIR absorbing agent. Exposure to NIR energy melts the capsule thereby expelling the curing agent and allowing for cure of the adhesive.

In accordance with the practice of the invention, the converter, in addition to applying adhesive to bond the facer to the fibrous batt, also applies to at least one predetermined location an amount of an adhesive that comprises an energy-absorbing ingredient. By including an energy-absorbing ingredient the absorption, reflection and transmission characteristics of the adhesive composition is tailored so as to optimize the composition's re-activation and subsequent bond formation. The adhesive is applied to the substrate and allowed to solidify. Such adhesives are capable of reactivating upon short duration of exposure to radiant energy, preferably less that about 10 seconds, more preferably less than about 5 seconds, even more preferably less than about 2 seconds, and provides acceptable bond force after a short period of compression or cooling, preferably a period of less that about 30 seconds, more preferably less than about 15 seconds.

Radiant energy can be supplied by a number of sources, as will be apparent to the skilled practitioner. Both coherent and non-coherent sources may be used. Examples include lasers, a high pressure xenon arc lamp, a coiled tungsten wire, ceramic radiant heater, tungsten-halogen lamps and ultrasonic waves. In a preferred embodiment, radiant energy within the near infra-red (NIR) region is used. Peak wavelengths of from 400 nm to about 100,000 nm may be used. More typically, wavelengths of from 700 nm to about 10,000 nm, most typically from about 750 nm to about 5000 nm will be used in the practice of the invention. Commercial sources of equipment capably of generating radiant heat required for use in the practice of the invention include Research Inc. (Eden Prairie, Minn.), Chromalox (Ogden, Utah), DRI (Clearwater, Fla.), Advent Electric Inc. (Bridgeport, Pa.), and Glo-Quartz Inc. (Mentor, Ohio).

The specific source of energy and distance from the surface to be irradiated will be dictated by the type and amount of adhesive used. In one embodiment, the energy source is NIR radiation. It is to be understood that the selection and duration of the radiant energy used will depend on the energy absorbing material incorporated into the adhesive located on the insulation blanket.

The insulation blankets of the invention will typically be coated with from about 0.5 mil to about 15 mil of adhesive. The adhesive present on the batting reactivates upon exposure to short durations of radiant energy and provide superior on-line performance and set speed which allows for quicker production speeds.

The energy-absorbing ingredient may be added, with stirring, any time during the preparation of the base adhesive, or following preparation of the base adhesive. The amount added will depend on the type of adhesive, the energy-absorbing ingredient used, the size of the energy-absorbing ingredient and the dissolution or dispersion properties of the energy-absorbing ingredient. The additive is added in an amount effective to reactivate the adhesive upon exposure to short durations (typically less that 10 seconds) of radiant energy. Typically, the additive will be present in an amount of about 0.001 to about 10 parts per 100 parts of the adhesive composition.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An insulation blanket comprising a insulating material having preapplied to at least a portion thereof a reactivatable hot melt adhesive, said reactivatable adhesive comprising an effective amount of an energy-absorbing ingredient such that upon exposure of the adhesive to radiant energy, the adhesive is activated.

2. The insulation blanket of claim 1 wherein said material comprises a fibrous material.

3. The insulation blanket of claim 1 wherein said material comprises foam.

4. The insulation blanket of claim 1 wherein said material comprises aerogel.

5. The insulation blanket of claim 1 wherein the preapplied adhesive is activated when exposed to radiant energy for a period of time of less than about 5 seconds.

6. The insulation blanket of claim 5 wherein the preapplied adhesive is activated when exposed to radiant energy for a period of time of less than about 2 seconds.

7. The insulation blanket of claim 1 wherein the adhesive preapplied to said insulation comprises an organic dye.

8. The insulation blanket of claim 1 wherein the adhesive preapplied to said insulation comprises a pigment.

9. The insulation blanket of claim 8 wherein the adhesive comprises carbon black.

10. The insulation blanket of claim 1 having a first major surface and a second major surface, wherein one of the first or second major surface has a facing sheet applied to said surface, and wherein the other of said first or second surface has said reactivatable hot melt adhesive applied to the said surface.

11. A product of manufacture comprising insulation, which insulation was secured in place by reactiving the hot melt adhesive present on a surface of the insulation blanket of claim 1.

12. A method of installing insulation having applied on at least a portion of a surface of said insulation a hot melt adhesive containing an effective amount of an energy-absorbing ingredient such that upon exposure of the adhesive to radiant energy, the adhesive is activated, the method comprising reactivating a hot melt adhesive preapplied to a substrate surface of the insulation, placing the reactivated adhesive in contact with a surface to be insulated, applying pressure, and allowing the adhesive to solidify, thereby bonding the insulation to said surface to be insulated.

13. A method of manufacturing a product comprising a fibrous insulation blanket, said method comprising reactivating a hot melt adhesive preapplied to a substrate surface of an insulation blanket, placing the reactivated adhesive in contact with a product surface, applying pressure, and allowing the adhesive to solidify, thereby bonding the insulation to the surface of the product.

14. The method of claim 13 wherein the product is a household or industrial product.

15. The method of claim 14 wherein the product is a HVAC unit.

16. A method of repairing the product claim 11 comprising reactiving the adhesive securing the insulation to said product, removing the insulation, repairing the product, reactivating the adhesive present on the removed insulation, contacting the reactivated adhesive with the product, and allowing the adhesive to solidify.

17. A method of laminating insulation components comprising reactivating a hot melt adhesive present on a surface of a first insulation component, placing the reactivated adhesive in contact with a surface of a second insulation component, applying pressure, and allowing the adhesive to solidify, thereby bonding the insulation components together.
